(19) United States
(12) Patent Application Publication
(10) Pub. No.: US 2005/0286256 A1
(43) Pub. Date: Dec. 29, 2005

(54) Small profile hanger system for ceiling suspended lighting fixtures

(75) Inventors: Michael Trung Tran, Oakland, CA (US); Hue Ly, Richmond, CA (US)

Correspondence Address: BEESON SKINNER BEVERLY LLP, ONE KAISER PLAZA, SUITE 750, OAKLAND, CA, 94612, US

(73) Assignee: Acuity Brands, Inc., Atlanta, GA (US)

(21) Appl. No.: 11/149,939

(22) Filed: Jun. 10, 2005

Related U.S. Application Data
(60) Provisional application No. 60/579,042, filed on Jun. 10, 2004.

(51) Int. Cl. F21S 8/06

(52) U.S. Cl. 362/404; 362/225; 362/147

(57) ABSTRACT

An improved small profile hanger system for ceiling suspended lighting fixtures comprises a plurality of hanger assemblies having a support stem and a downwardly arced crossbar. The support stem and crossbar have a relatively small elliptical profile have two sets of wire holes, each set of wire holes having an inner hole and an outer hole overlapping the inner hole, the inner and outer holes defining an intervening gap narrower than the dimension of either hole. The holes are sized to receive an insulated wire; the intervening gap preventing the wire from crossing over into the adjacent hole. The wire holes of the support stem are in communication with the wire holes of the crossbar providing a fully enclosed wiring passage from a ballast box assembly installed above a suspended ceiling to energize a lamp in a diffuser depending from a pair of the crossbars.

### CROSS-REFERENCE TO RELATED APPLICATIONS

This application claims the benefit of U.S. Provisional Application No. 60/579,042, filed Jun. 10, 2004.

### BACKGROUND OF THE INVENTION

The present invention relates to lighting fixture hanger systems and particularly hanger systems for small profile ceiling suspended lighting fixtures.

Lighting for interior architectural spaces is often provided by lighting fixtures suspended from overhead ceiling structures. Examples of ceiling suspended architectural lighting fixtures include linear fluorescent fixtures comprised of linear fixture housings having a uniform cross-sectional shape. Such fixtures are typically suspended by steel aircraft cable or rigid hollow stems, and would have relatively bulky power cords that would have to be run up through the ceiling for connection to an electrical junction box. Where fixtures are suspended by aircraft cable, the power cord for each fixture would normally be run up and sometimes wrap around the suspension cables; in the case of stem suspensions, the power cord would be run up through the hollow stem. While stems have the advantage that they hide the power cord, they are themselves relatively large in diameter and do not contribute to an aesthetically pleasing hanger system, and particularly hanger systems having small profiles.

A need exists for a hanger system that can be used to suspend relatively small profile lighting fixtures, such as linear fluorescent lighting fixtures that have been devised for compact T-5 lamps. A need also exists for a hanger system having components of a smaller profile than exists in large diameter stems, while allowing for the wiring of the fixture through the hanger system. A need further exists for a hanger system that allows wires to be pulled through the hanger system components relatively easily without becoming tangled. Yet another need exists for a small profile, lightweight hanger system that is relative easy to install, and that is physically and aesthetically compatible with small profile lighting fixtures.

### SUMMARY OF THE INVENTION

An approved small profile hanger system for ceiling suspended lighting fixtures comprises a plurality of hanger assemblies, each hanger assembly including a vertical support stem and a downwardly arced cross bar. A bottom portion of the support stem is secured to the apex of the cross bar. The support stem and cross bar have a common profile comprising two half sections, each half section having a generally elliptical shape, together generally resembling a “cat's eye” shape. Two pairs of wire holes extend through the entire length of both the support stem and cross bar. The wire holes are generally aligned along the wider dimension of the profile of the stem and cross bar. Each pair of holes consists of an inside and outside hole. The inside and outside holes overlap, forming an intermediate gap narrower than the dimension of either of the holes. Each hole is sized to receive an insulated wire, such as an 18 gauge insulated lamp wire. The narrowness of the intermediate gap is such that any wire being fed through one of the wire holes is prevented from crossing over into the other wire hole. Preferably, the inside hole is slightly smaller than the outside hole, the combination of the reduced hole size and intermediate gap still providing adequate room for feeding wires into the wire holes. The reduced hole size has the advantage of a corresponding increase in material of the stem and cross bar, increasing the strength of the stem and cross bar. A center bore also extends through the entire length of the stem and cross bar to lighten these elements.

Two top side exit ports in the apex of the cross bar are in communication with the two pairs of wire holes in the cross bar. The exit ports are in turn in communication with the pairs of wire holes in the support stem. The wire holes in the support stem are thus in communication, via the exit ports, with the wire holes in the cross bar, together providing a fully enclosed wiring passage extending from the top of the support stem to the ends of the cross bar.

In one aspect of the invention, the top of the support stem is attached to a ballast box assembly installed over a T-bar suspended ceiling system. Each end of the cross bar is attached to one end of a diffuser housing. Lamp wires extending from the ballast through the support stem and cross bars to the diffusers energize a lamp disposed in the diffusers. In another aspect of the invention, each diffuser includes an end plate, lateral flanges on which fit within opposing recesses on the upper edges of the diffuser. A reflector is interposed between and attached to each end plate. The end of each cross bar is connected to the cover plate with a connector bracket.

The improved hanger system is light-weight, has a relatively small profile, provides a hidden wiring passage for extending wiring from the ballast assembly above the ceiling to the lamp in the diffuser housing, and the entire system is easy to assemble. Preferably the hanger elements are constructed of extruded aluminum.

### BRIEF DESCRIPTION OF THE ILLUSTRATIONS

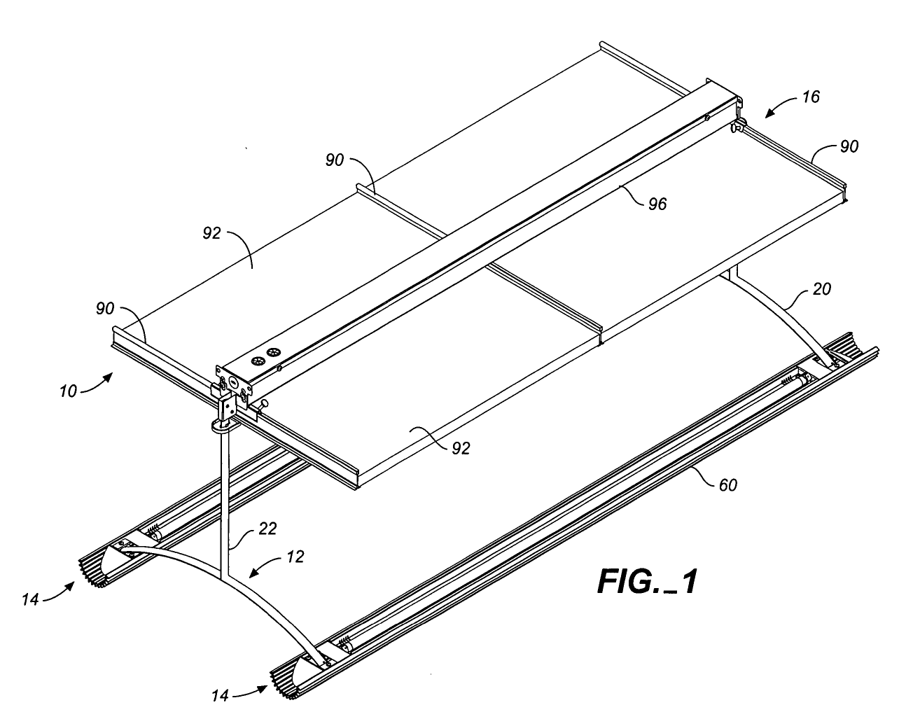

FIG. 1 is a top perspective view of a lighting assembly comprised of small profile indirect lighting fixtures and a hanger system in accordance with the invention for suspending the lighting assembly below a grid ceiling system.

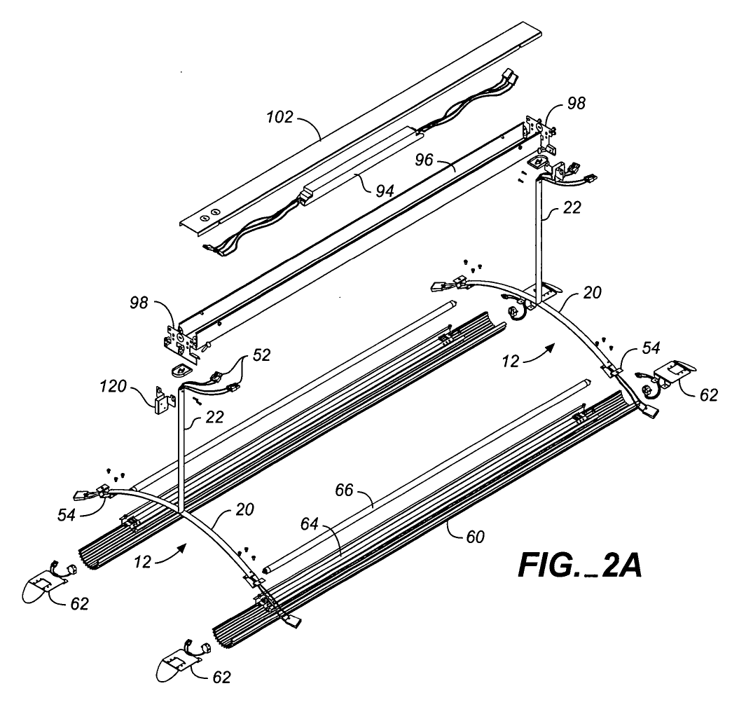

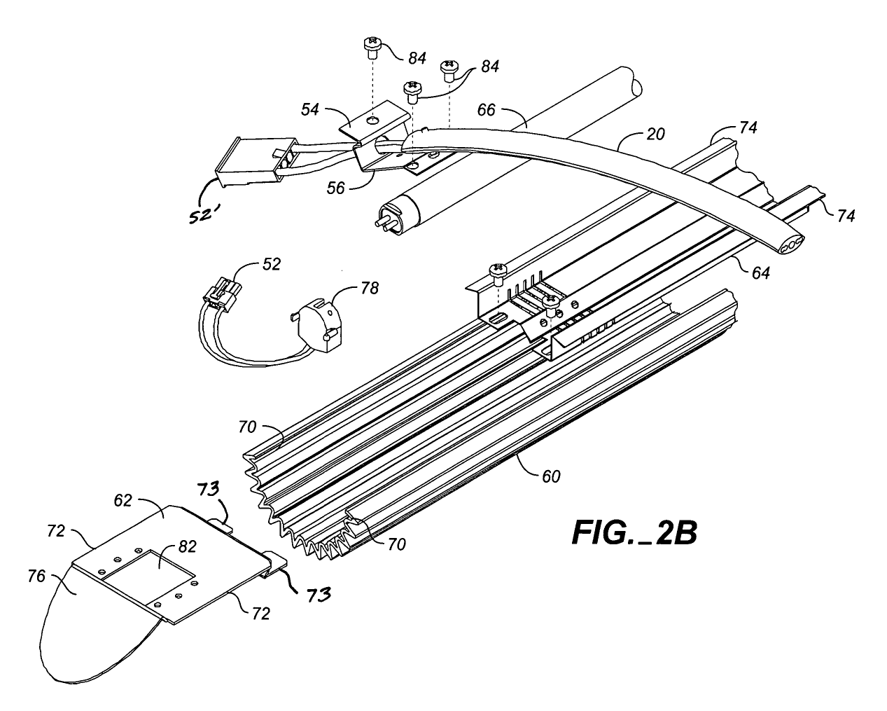

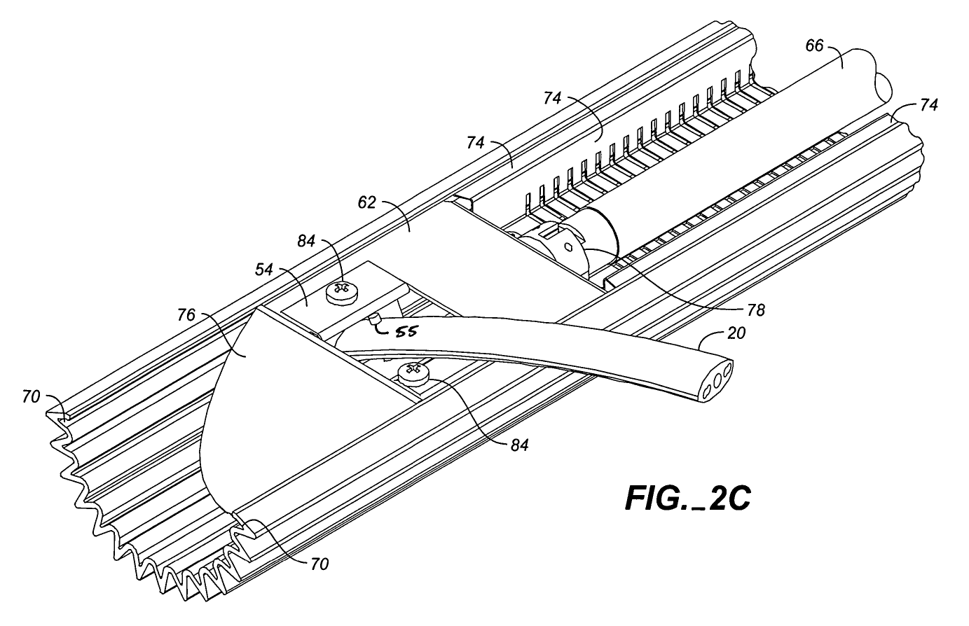

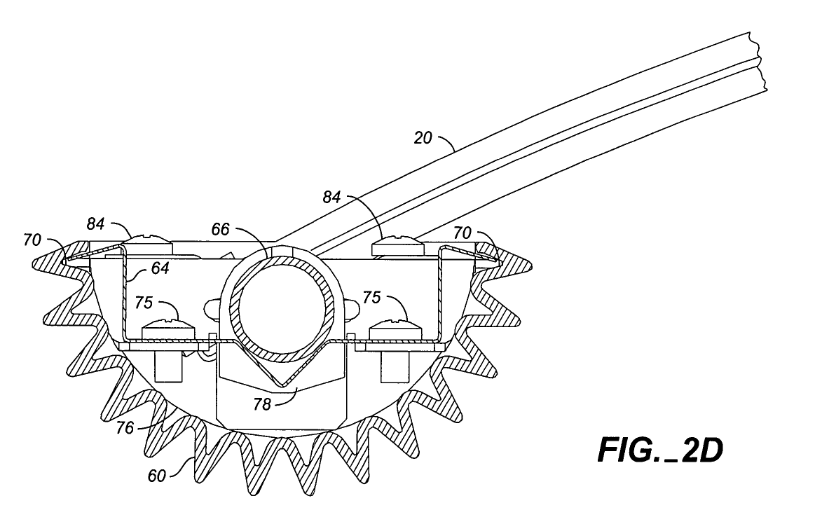

FIG. 2A is an exploded view thereof.

FIG. 2B is an exploded fragmentary view thereof showing in greater detail the connection of the hanger system of the invention to one of the lighting fixtures of the assembly.

FIG. 2C is a fragmentary view of the portion of the assembly shown in FIG. 2B fully assembled.

FIG. 2D is a cross-sectional view of one of the lighting fixtures suspended by the hanger system of the invention as shown in FIG. 1.

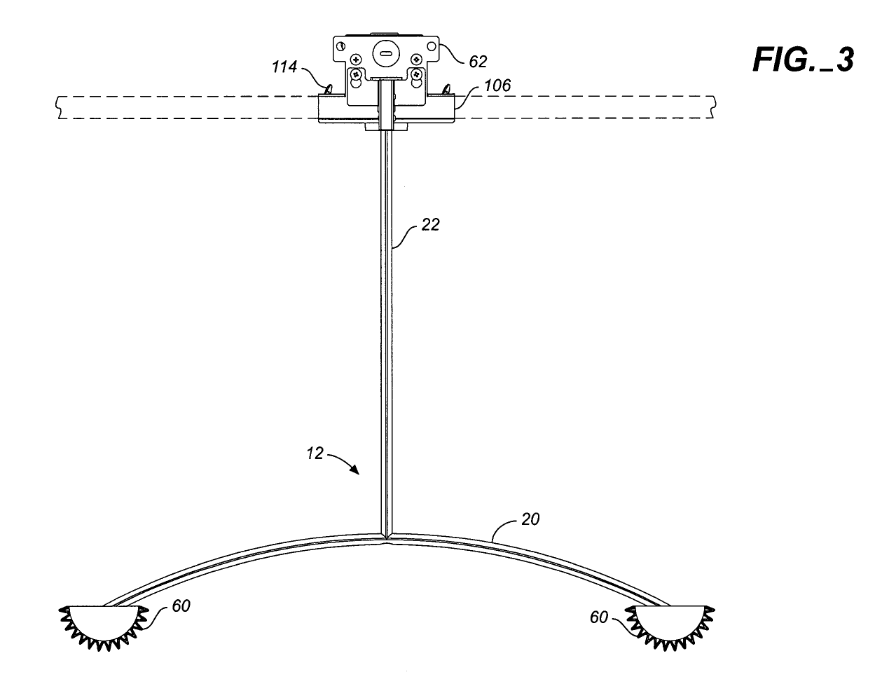

FIG. 3 is an end elevational view of the small profile indirect lighting fixtures and a hanger system shown in FIG. 1.

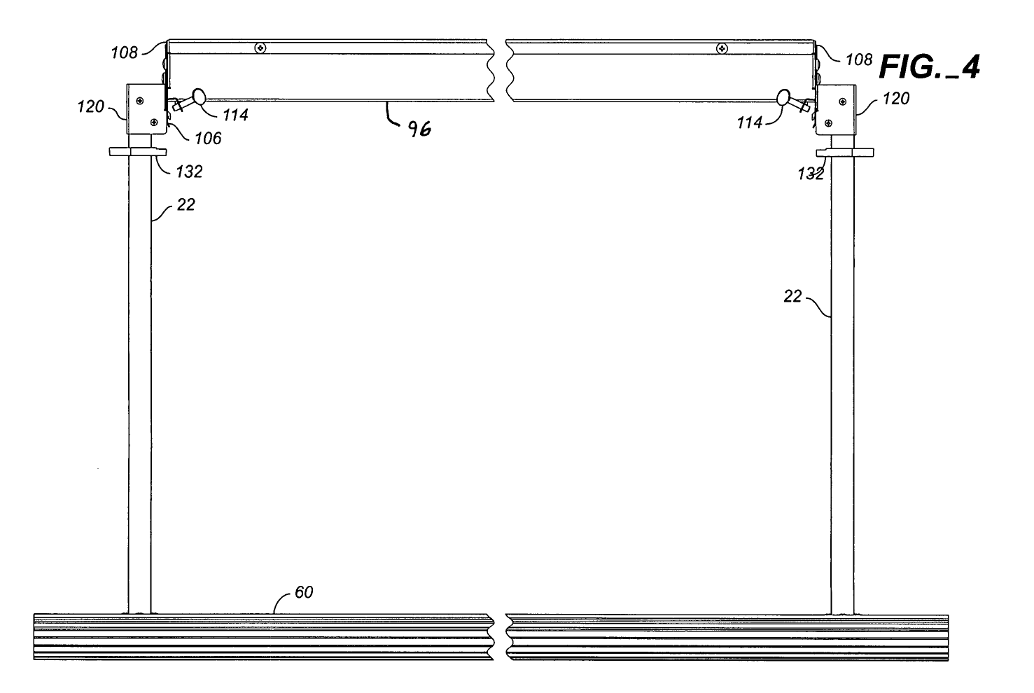

FIG. 4 is a side elevational view thereof.

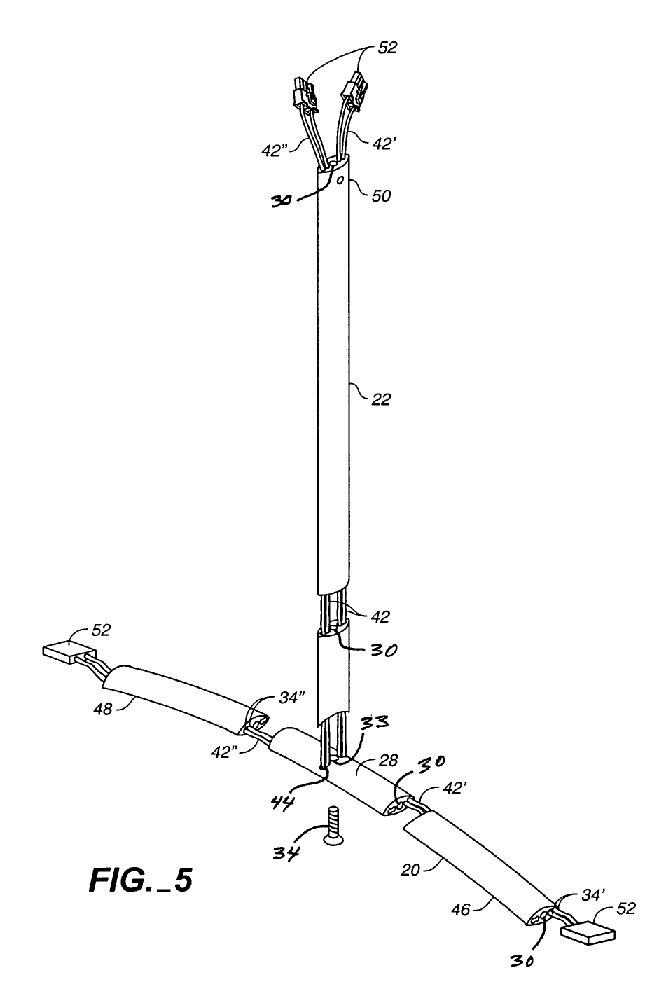

FIG. 5 is a top perspective view, partially cut-away, of one of the hangers for the indirect lighting fixtures shown in FIG. 1.

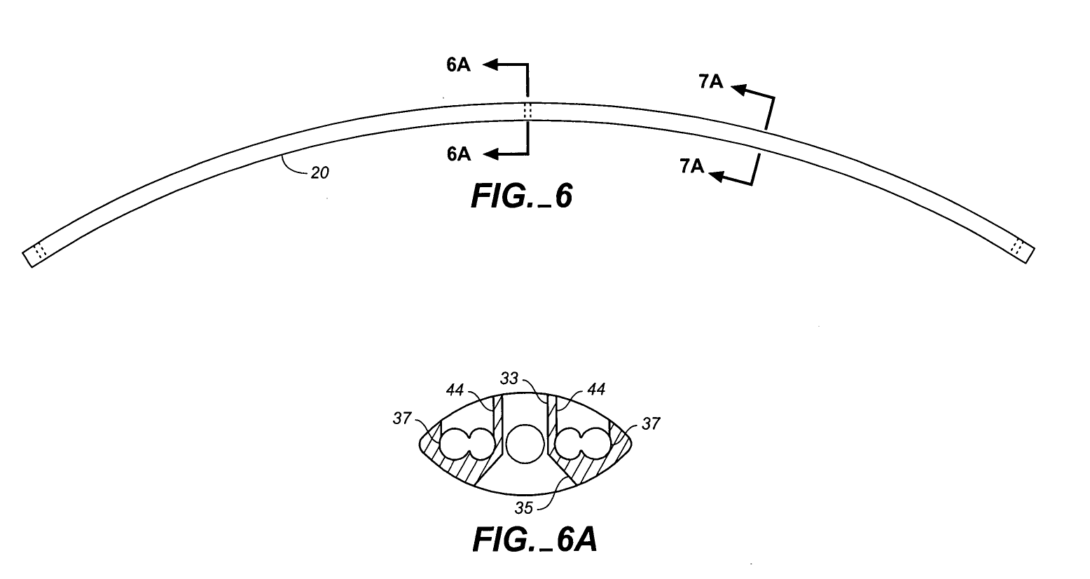

FIG. 6 is a side elevational view of the curved cross-piece of the hanger shown in FIG. 5.

FIG. 6A is a cross-sectional view thereof taken along lines 6A-6A of FIG. 6.

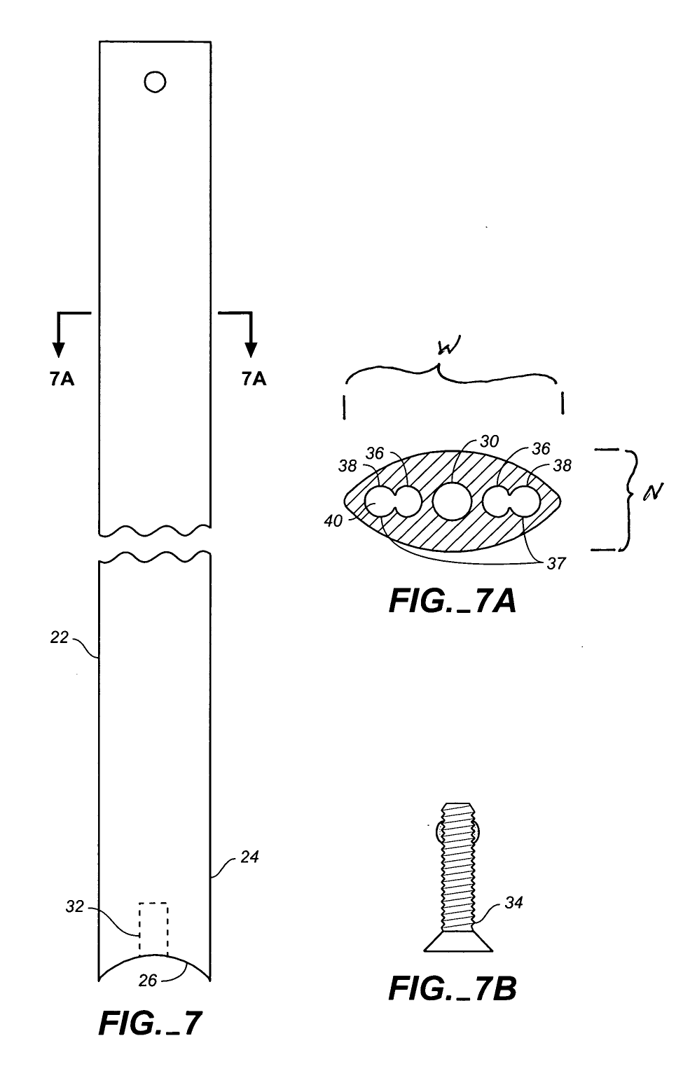

FIG. 7 is a side elevational view of the vertical support stem of the hanger shown in FIG. 5.

FIG. 7A is a cross-sectional view thereof taken along lines 7A-7A of FIG. 7.

FIG. 7B is a side elevational view of the locking screw used to attach the curved crossbar shown in FIG. 6 with the vertical support stem shown in FIG. 7.

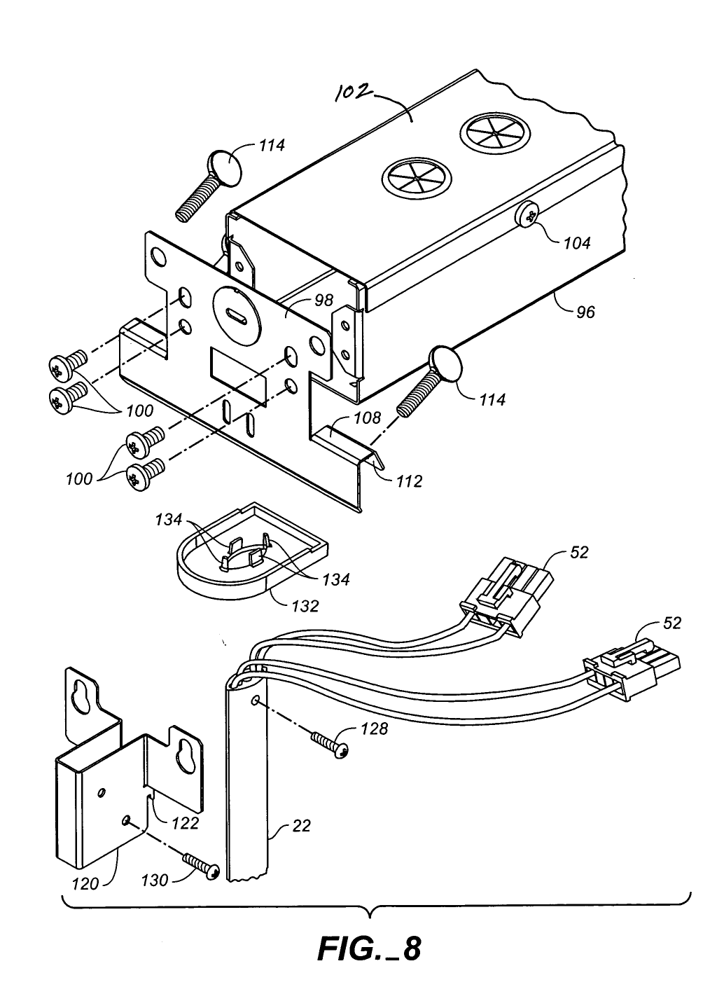

FIG. 8 is and exploded top perspective view of the end of the ballast box and of the hanging hardware used for hanging the indirect lighting fixtures in FIG. 1 from the ends of the ballast box.

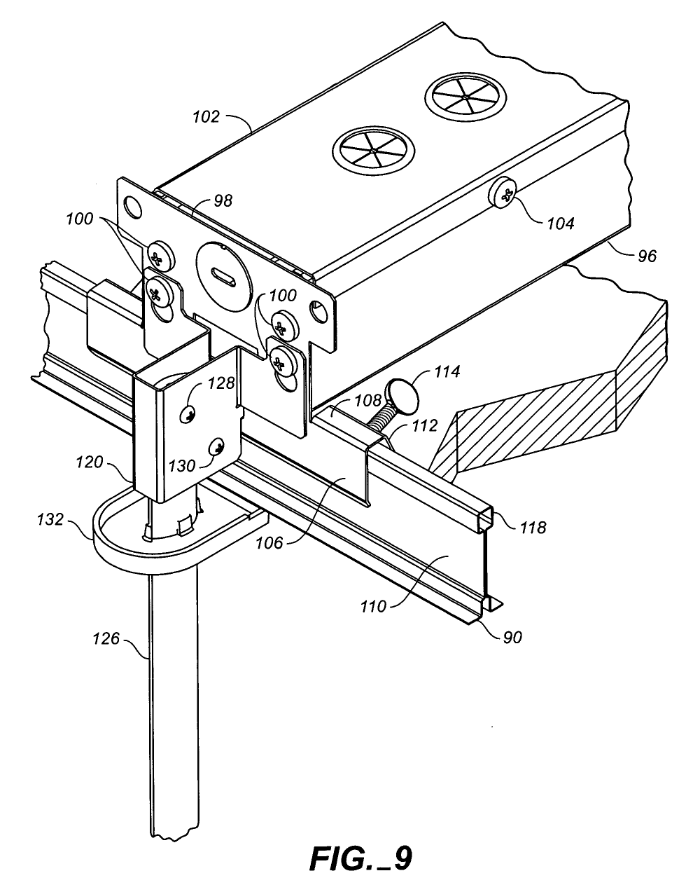

FIG. 9 is an assembled top perspective view thereof.

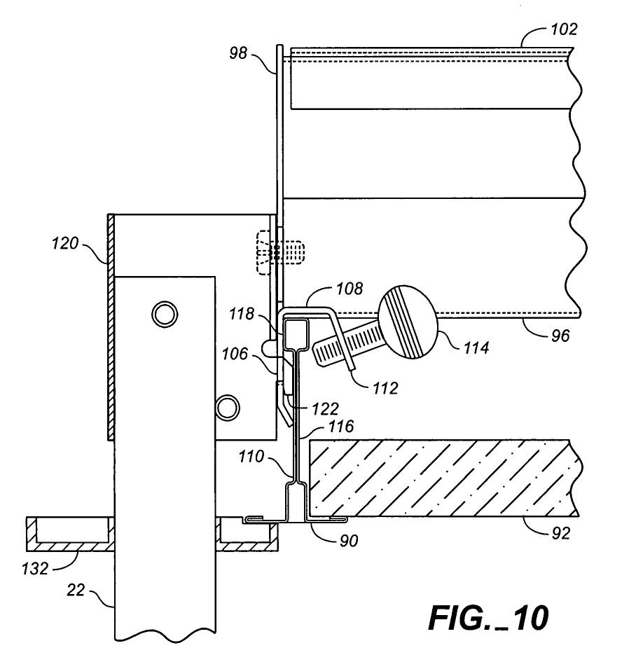

FIG. 10 is an assembled side elevational view thereof.

### DESCRIPTION OF THE ILLUSTRATED EMBODIMENT

With reference to the attached illustrations, a ceiling suspended lighting fixture 10 comprises a hanger assembly 12, dual elongated indirect lighting fixture elements 14 preferably having T-5 high output fluorescent lamps, and a ballast box assembly 16.

The hanger assembly 12 comprises a pair of hangers for suspending the ends of the indirect lighting fixture elements 14. Each hanger has a downwardly arched crossbar 20 depending from a vertical support stem 22. The crossbar 20 and support stem 22 are suitably made from extruded aluminum with a heavy etched surface. In the preferred embodiment, the crossbar 20 and support stem 22 have a common generally elliptical cross-section best seen in FIG. 7A, but alternate embodiments could assume other shapes such as a diamond-shaped or cylindrical cross-section. Referring now to FIG. 7, a lower end 24 of the support stem 22 terminates in an concave surface 26 for mating engagement with the convex outer surface 28 of the crossbar 20 as perhaps best seen in FIG. 5. A center bore 30 extends through the entire length of both the support stem 22 and the crossbar 20. At the lower end 24 of the support stem 22 the center bore 30 has a threaded portion 32. As shown in FIG. 6A a vertical hole 33 is provided in the crossbar 20 to accept a threaded fastener 34. The crossbar 20 is attached to the support stem 22 with the threaded fastener 34 which engages the threaded portion 32 of the center bore 20 of the support stem 22. In the preferred embodiment, the bottom portion 35 of the bore 20 is cone-shaped to accommodate a beveled-head screw. It will be appreciated that other hole entrance shapes could be used. A self-locking screw may be used to prevent the screw from loosening over time.

Referring again to FIG. 7A, two pairs of wire holes 37 extend through the entire length of both the support stem 22 and crossbar 20. Each pair of wire holes comprises an inside hole 36 and an outside hole 38. The inside and outside holes 36, 38 overlap forming an intermediate gap 40. The inside hole 36 of each hole pair is slightly smaller than the outside hole 38. The small reduction in the size of the inside hole 36 permits a corresponding increase in the amount of material in the cross-sections of the crossbar 20 and the support stem 22 for improved strength. This, in turn, allows reduction of the cross-section of the hanger elements 20, 22 to a more compact size. Preferably, the narrow diameter N of the cross-section is approximately 0.358″ and the widest diameter W is 0.750″, but the invention is not limited to those dimensions, the cross-section capable of assuming myriad dimensions in alternate embodiments. In the preferred embodiment, the pairs of wire holes are in planar alignment with he widest diameter of the profile as seen in FIGS. 6A and 7A.

Referring again to FIG. 5, each hole 36, 38 is sized to receive an 18 gauge insulated wire 42 such that a pair of like wires can easily be fed through the holes without becoming entangled. Conversely, the hole is sufficiently small that when a wire is fed into one of the holes it is unlikely to bend. The intermediate gap 40 between holes 36, 38 is sufficiently smaller than the diameter of the 18-gauge wire that the wires 42 do not cross over into the adjacent hole when they are being fed through the wire holes 37. It will be readily appreciated by those of skill in the art, that the invention is not limited to 18 gauge insulated wire and holes sized to receive 18 gauge insulated wire, and that other embodiments of the invention could have other wire and hole sizes.

Referring to FIGS. 6 and 6A, wire exit ports 44 in the top side of the apex of the crossbar 20 intersect with the wire holes 37 in the support stem 22. Accordingly, with additional reference to FIG. 5, construction of the hanger assembly 12 involves feeding a first pair of lamp wires 42′ into a first pair of wire holes 34′ from a first end 46 of the crossbar 20. When the wire ends appear in the exit port 44 they are then fished out and fed through a corresponding pair of wire holes 34 in the support stem 22. Similarly, a second pair of lamp wires 42″ are fed into the second pair of wire holes 34″ from a second end 48 of the crossbar 20 until their ends appear in the intersecting exit port 44. The second pair of lamp wires 42″ are then fished out and fed through the corresponding pair of wire holes 34 in the support stem 22. Once the crossbar 20 is attached to the support stem 22, the first pair of lamp wires 42′ will extend from the first end 46 of the crossbar 20 to the top end 50 of the support stem 22 and the second pair of lamp wires 42″ will extend from the second end 48 of the cross beam 20 to the top end 50 of the support stem 22, both pairs of lamp wires 42 being completely enclosed and hidden from view within the hanger elements. Incorporating the wire holes 37 in the hanger elements 20, 22 provides a fully enclosed wiring passage for wiring of the fixture element 14 to the ballast through the hanger elements. Snap connectors 52 are attached to the ends of each pair of lamp wires.

Referring to FIGS. 2B and 2C, connector brackets 54 are attached to each end of the crossbar 20 with a threaded fastener 55 from beneath. Each connector bracket 54 includes a bottom channel portion 56 for receiving the ends of the crossbar 20.

Each indirect lighting fixture element 14 comprises a diffuser housing 60, an end plate 62, a reflector 64, and a lamp 66. As best seen in FIG. 3 the diffuser housing 60 preferably has a generally annular cross-section with a crenulated profile. The upper portions of the sides of the diffuser housing terminate in opposing recesses 70. See FIG. 2D. Laterally extending flanges 72 on the sides of the end plate 62 (see FIG. 2B) slide into the recesses 70. The width across the end plate 62 to the outer edges of the flanges 72 is slightly larger than the outermost extent of the recesses 70 of the diffuser housing 60 such that insertion of the end plate 62 between the recesses 70 requires the diffuser to flex outwardly slightly causing the diffuser housing 60 to bias inwards effectively holding the end plate 62 longitudinally in place. Similarly, laterally projecting flanges 74 on the reflector 64 slidingly inserted into the recesses 70 of the diffuser housing 60 retain the reflector 64 in the diffuser housing 60. The reflector 64 is interposed between end plates 62 installed on each end of the diffuser housing 60 and secured to each inwardly extending tabs 73 on the end plates with fasteners 75. The outer end of each end plate 62 has a downwardly angled cover plate 76 having a parabolic periphery for intersecting with the inside of the diffuser housing 60 as seen in FIG. 2C. A lamp socket 78 is attached to the inner end of each end plate 62 to allow a lamp 66 to be mounted in the diffuser housing 60. Each lamp socket is back-wired and snap connectors 52 are attached to the wires. On the top side of each end plate 62 a mounting hole 82 is provided to receive the recessed portions 56 of the connector brackets 54 of the hanger assembly 12. Once the snap connector 52 at the end of the crossbar 20 is connected to the cooperating snap connector 52′ of the lamp socket 78, the bottom channel portion 56 of the connector bracket 54 is inserted through the mounting hole 82 in the end plate 62 and secured to the end plate 62 with threaded fasteners 84.

As shown in FIG. 1, a ceiling suspended light fixture 10 according to the invention is installed in a ceiling system comprised of a grid of T-bars 90. The ceiling tiles 92 are supported by and between adjacent T-bars. With reference now to FIG. 2A, a ballast 94 is disposed in a ballast box 96. Referring also to FIG. 8, end caps 98 are attached to each end of the ballast box 96 with threaded fasteners 100, and a ballast box cover 102 is secured to the top of the ballast box 96 with threaded fasteners 104. With additional reference to FIG. 4, it is seen that a lower portion 106 of the end cap 98 extends below the ballast box 96. Support brackets 108 (see FIG. 8) project inwardly from the lower portion 106 for resting on a T-bar 90 so that the lower portion 106 of the end cap 98 rests against a first side 110 of the T-bar 90. See FIG. 9. An inner lip 112 projects downwardly at an oblique angle to ease installation of the support brackets 108 on the T-bar grid. With reference to FIG. 10, thumbscrews 114 are inserted through the inner lip 112 such that when tightened the thumbscrews 114 advance towards a second side 116 of the T-bar 90 to secure the T-bar 90 between the lower portion 106 and the thumbscrew 114. A T-bar of typical construction has an enlarged head 118. Thus, the downward angle of the thumbscrew 114 helps ensure that when fully tightened its end is disposed below the head 118 of the T-bar 90. The configuration of the support brackets 108 thus securely locks the end caps 98 both horizontally and vertically on the T-bar grid. See FIGS. 9 and 10.

A hanger bracket 120 is attached to each end cap 98 first by inserting hooks 122 into openings 124 then pressing the hanger bracket 120 down to secure the hooks in the openings as shown in FIGS. 8-10. The hanger bracket 120 is then fastened to the end cap 98 with threaded fasteners 100. Dual fastening of the hanger bracket 120 to the end cap 98 using the hooks 122 and fasteners 100 prevents the hanger bracket from rocking, e.g., in the event of an earthquake. The upper end 126 (see FIG. 9) of the support stem 22 attaches to the hanger bracket 120 with a threaded fastener 128. A laterally displaced lower fastener 130 inserted in the hanger bracket 120 immediately adjacent the support stem 22 squeezes the hanger bracket 120 firmly around the support stem 22. During field installation of the fixture, a small portion (not illustrated) of a ceiling tile 92 is removed to create a ceiling aperture through which the support stem 22 is inserted. A canopy 132 is installed on the support stem 22 to mask the ceiling aperture. Fingers 134 bias inwardly to hold the canopy onto the support stem 22. The hanger assembly 12 and diffuser assemblies 14 are thus suspended from the ballast assembly 16, the latter being hidden from view above the ceiling tiles.

A suspended ceiling fixture 10 as described is easy to assemble and install, is fabricated from standard aluminum materials which are strong enough to hold the weight of the fixture elements at their outboard ends yet retain a small and aesthetically pleasing compact profile, and is light weight, the illustrated embodiment of the hanger and diffuser assemblies weighing less than 5 lbs. The lightness of the fixture may avoid triggering earthquake code requirements in earthquake prone areas for suspended ceiling fixtures.

There have thus been described certain preferred embodiments of an improved small profile hanger system for ceiling suspended lighting fixtures. While preferred embodiments have been described and disclosed, it will be recognized by those with skill in the art that modifications are within the true spirit and scope of the invention. The appended claims are intended to cover all such modifications.

1. A hangar system for lighting fixtures of the type depending from a ballast box disposed above a suspended ceiling, the lighting fixtures further having a plurality of lighting fixture elements depending from the hangar system, the hangar system comprising:
a plurality of hangars, each hangar having a vertical support stem and a downwardly arced crossbar, said support stem having a top portion and a bottom portion, said top portion secured to the ballast box, said crossbar having an apex attached to said bottom portion of said support stem, said crossbar having two ends,
said support stem having extending through its entire length first and second pairs of support stem wire holes, said crossbar having extending through its entire length first and second pairs of crossbar wire holes, said crossbar having at said apex first and second top side exit ports, said first exit port in communication with said first pair of crossbar wire holes and said second exit port in communication with said second pair of crossbar wire holes, said first pair of support stem wire holes in communication with said first exit port, said second pair of support stem wire holes in communication with said second exit port, said wire holes and exit ports defining an enclosed wiring passage for lamp wires extending from the ballast to lighting fixture elements depending from said ends of said crossbars.

2. The hangar system of claim 1 wherein:
each of said pairs of support stem wire holes and crossbar wire holes have an inside hole and an outside hole overlapping said inside hole, said inside and outside holes defining there between an intermediate gap, each of said inside and outside holes sized to receive slidingly an insulated wire, said intermediate gap being sufficiently small that an insulated wire in one of said inside and outside holes cannot cross over into the other of said holes.

3. The hangar system of claim 2 wherein:
said insulated wire comprises an 18 gauge wire.

4. The hangar system of claim 2 wherein:
said support stem and said crossbar each have a common profile having two opposite half sections, each half section having a generally elliptical profile, and
said inside hole is slightly smaller than said outside hole.

5. The hangar system of claim 4 wherein:
said profile of said support stem and said crossbar is relatively small having a has a narrow dimension and a wide dimension, said narrow dimension being approximately 0.358″ and said wide dimension being approximately 0.750″.

6. The hangar system of claim 4 wherein:
said support stem and said crossbar are made from extruded aluminum.

7. The hangar system of claim 1 wherein:
said bottom portion of said support stem includes a threaded center hole,
said apex of said crossbar includes a vertical fastener hole, and
a threaded fastener is disposed in said fastener hole and threadedly inserted into said center hole of said support stem.

8. The hangar system of claim 7 wherein:
said support stem and said crossbar each have a common profile having two, opposite half sections, each half section having a generally elliptical profile,
said bottom portion of said support stem has a concave lower surface cooperating with said elliptical profile of said crossbar.

9. The hangar system of claim 1 wherein:
said support stem and said crossbar each have a center bore extending through their entire length.

10. The hangar system of claim 1 further comprising:
a plurality of lighting fixture elements, each fixture element having a lamp and two end portions, each said end portion secured to one of said ends of said crossbar, and
first and second sets of lamp wires disposed in said wire holes, each said set of lamp wires including a pair of insulated wires, said sets of lamp wires extending from said ballast box assembly to one of the lighting fixture elements for energizing said lamp.

11. The hangar system of claim 1, further comprising:
the ballast box having end caps, each end cap having dual spaced parallel slots and a pair of fastener holes,
a plurality of hangar brackets, each hangar bracket having an extending outwardly U-shaped vertical channel having parallel side walls, each side wall having a proximal edge, an upper fastener hole, a lower fastener hole, a distal wall extending between said side walls, a pair of laterally flared ears extending from said proximal edges of said side walls, said ears each having a fastener hole, and a pair of downwardly directed hooks extending inwardly from said proximal edges of said side walls, said hooks removably disposed in said slots of one of said end caps,
said support stem having an upper portion, an outer edge, an inner edge, and a horizontal fastener hole, said upper portion of said support stem snugly received in said channel, a first threaded fastener threadedly disposed in said upper fastener holes of said side walls and in said fastener hole of said upper portion of said support stem, a second threaded fastener threadedly disposed in said lower fastener holes of said side walls, said outer edge of said upper portion of said support stem disposed against said distal wall of said hangar bracket, said second threaded fastener disposed adjacent said inner edge of said upper portion of said support stem, said second threaded fastener biasing said side walls of said channel inwardly against said upper portion of said support stem, and
a pair of threaded fasteners threadedly disposed in said fastener holes of said ears of said hangar brackets and said pair of fastener holes of one of said end caps.

12. The hangar system of claim 1 further comprising:
a canopy having an aperture for receiving said support stem, said canopy having a plurality of fingers arranged around the periphery of said hole, said fingers biased inwardly against said support stem.

13. The hangar system of claim 1 further comprising:
the lighting fixture elements including a plurality of longitudinally extending diffusers, each diffuser having a generally elliptical downwardly oriented cross-section and two parallel upper edges, said upper edges having opposing inwardly directed recesses,
a plurality of end plates, each end plate having a pair of oppositely disposed laterally extending flanges defining a lateral dimension of said end cap, said flanges received in sliding disposition in said recesses, said lateral dimension slightly greater than the distance between said recesses causing said recesses to be biased inwardly against said flanges.

14. The hangar system of claim 13 further comprising:
said diffuser having an interior surface, and said end plate having a downwardly angled cover plate having an elliptical edge intersecting with said interior surface.

15. The hangar system of claim 13 further comprising:
said crossbars each having two ends, and
a plurality of connector brackets, each connector bracket affixed to an end of one of said crossbars, said connector bracket secured to one of said end plates.

16. The hangar system of claim 1 further comprising:
said crossbars each having two ends, and
the lighting fixture elements including a plurality of longitudinally extending diffusers, each diffuser having opposite ends and a pair of end plates removably disposed in each said end, a reflector interposed between said end plates, and one end of each crossbar affixed to each one of said end plates.

17. A hangar system for lighting fixtures of the type depending from a ballast box disposed above a suspended ceiling, the lighting fixtures further having a plurality of lighting fixture elements depending from the hangar system, the hangar system comprising:
a plurality of hangars, each hangar having a vertical support stem and a downwardly arced crossbar, said support stem having a top portion and a bottom portion, said top portion secured to the ballast box, said crossbar having an apex attached to said bottom portion of said support stem, said crossbar having two ends,
said support stem having extending through its entire length first and second pairs of support stem wire holes, said crossbar having extending through its entire length first and second pairs of crossbar wire holes, each of said pairs of support stem wire holes and crossbar wire holes having an inside hole and an outside hole overlapping said inside hole, said inside and outside holes defining there between an intermediate gap, said inside hole slightly smaller than said outside hole, said support stem and said crossbar each having a common profile having two opposite half sections, each half section having a generally elliptical profile, said profile defining a wide dimension, said pairs of wire holes of said support stem and of said crossbar disposed in parallel alignment with said wide dimension, each of said inside and outside holes sized to receive slidingly an insulated wire, said intermediate gap being sufficiently small that an insulated wire in one of said inside and outside holes cannot cross over into the other of said holes,
said crossbar having at said apex first and second top side exit ports, said first exit port in communication with said first pair of crossbar wire holes and said second exit port in communication with said second pair of crossbar wire holes, said first pair of support stem wire holes in communication with said first exit port, said second pair of support stem: wire holes in communication with said second exit port, said wire holes and exit ports defining an enclosed wiring passage for lamp wires extending from the ballast to lighting fixture elements depending from said ends of said crossbars.
